(19) United States
(12) Patent Application Publication
(10) Pub. No.: US 2015/0370645 A1
(43) Pub. Date: Dec. 24, 2015

(54) SELECTING A BACKUP TYPE BASED ON CHANGED DATA

(71) Applicant: HEWLETT-PACKARD DEVELOPMENT COMPANY, L.P., Houston, TX (US)

(72) Inventors: Hari Dhanalakoti, Bangalore (JP); Ganesh Kolli, Bangalore (IN); Sreekanth Gopisetty, Hyderabad (IN)

(21) Appl. No.: 14/764,746

(22) PCT Filed: Feb. 27, 2013
(86) PCT No.: PCT/US2013/027855

§ 371 Date: Jul. 30, 2015

(51) Int. Cl. G06F 11/14

(52) U.S. Cl. CPC G06F 11/1451; G06F 11/1461; G06F 2201/84

(57) ABSTRACT

Techniques for selecting a backup type based on changed data are described in various implementations. An example method that implements the techniques may include identifying a backup policy that describes a source of data to be backed up during a backup operation. The method may also include determining an amount of data that has changed on the source since a previous backup of the source. The method may also include selecting a type of backup to perform based on the amount of data that has changed on the source. The method may also include causing the backup operation to be performed using the selected type of backup.

### BACKGROUND

Many companies place a high priority on the protection of data. In the business world, the data that a company collects and uses is often the company's most important asset, and even a relatively small loss of data or data outage may have a significant impact. In addition, companies are often required to safeguard their data in a manner that complies with various data protection regulations. As a result, many companies have made sizeable investments in data protection and data protection strategies.

As one part of a data protection strategy, many companies perform backups of portions or all of their data. Data backups may be executed on an as-needed basis, but more typically are scheduled to execute on a recurring basis (e.g., nightly, weekly, or the like). Such data backups may serve different purposes. For example, one purpose may be to allow for the recovery of data that has been lost or corrupted. Another purpose may be to allow for the recovery of data from an earlier time—e.g., to restore previous versions of files and/or to restore a last known good configuration.

### BRIEF DESCRIPTION OF THE DRAWINGS

FIG. 1 shows a conceptual diagram of an example backup environment in accordance with implementations described herein.

FIGS. 2A, 2B, and 2C show examples of backup scenarios in accordance with implementations described herein.

FIG. 3 shows a flow diagram of an example process for performing a backup using a selected backup type in accordance with implementations described herein.

FIG. 4 shows a block diagram of an example system in accordance with implementations described herein.

### DETAILED DESCRIPTION

A backup system may protect vital data, e.g., in a datacenter, by storing the backed up data in a persistent destination store. The destination store may include single or multiple storage devices of similar or disparate storage types, such as tape devices, tape libraries, or disk devices (local and/or network-based). Such destination stores may allow for the backup of large amounts of customer data that is backed up, e.g., from file systems, database servers, application servers, or the like.

Backup administrators may define backup policies that specify how and when to perform backup operations. For example, backup policies may specify the source (or sources) of data to be backed up, a schedule for performing the backups of that source, the type of backups to be performed, and other appropriate information describing how the backup operations are to be performed. Examples of the types of backups to be performed may include full backups (where all of the selected data from a particular source is backed up), cumulative incremental backups (where all changes since the last full backup are backed up), differential incremental backups (where only the portions changed since the last full or cumulative incremental backup are backed up), or other appropriate types of backups. Some backup policies may include a combination of these alternatives (e.g., full backups on the weekend, followed by daily cumulative incremental backups during the week).

In many instances, the time between creation of the backup policy and execution of the backup policy may be significant, and oftentimes the data to be backed up from a given source may be relatively dynamic. In such instances, it may be very difficult for a backup administrator to accurately predict, for all given possible scenarios, what types of backups may be most beneficial in a particular case. As such, the type of backup defined in the policy for the particular case may turn out to be wasteful of resources. For example, the backup policy may specify a full backup when an incremental backup would be sufficient (e.g., wasting time and storage resources), or conversely, the backup policy may specify an incremental backup when a full backup would be more appropriate (e.g., causing restore operations to take more time than would otherwise be necessary). Unfortunately, backup administrators often do not have time to manually verify, on a case-by-case basis, whether the backup type defined for a particular scenario will provide the most efficient usage of resources.

According to the techniques described here, a backup computing system may automatically select a type of backup to use (e.g., full backup, incremental backup, or other appropriate type of backup) during a particular backup scenario based on current information available for the backup scenario. For example, at runtime of the backup operation, the backup computing system may determine the amount of data that has changed since a previous backup, and may select an appropriate type of backup to perform in that particular instance based on the amount of changed data.

The techniques described here may be used, for example, to increase the efficiency of backup systems by applying a situation-appropriate backup type to a backup operation. In some cases, the techniques may ensure that the backup windows during which backup operations are performed are used in an efficient manner, which may also lead to increased backup success rates. In addition, the techniques may ensure that backup resources (e.g., storage capacity, network bandwidth, and administrator time) are used more efficiently during backup operations. These and other possible benefits and advantages will be apparent from the figures and from the description that follows.

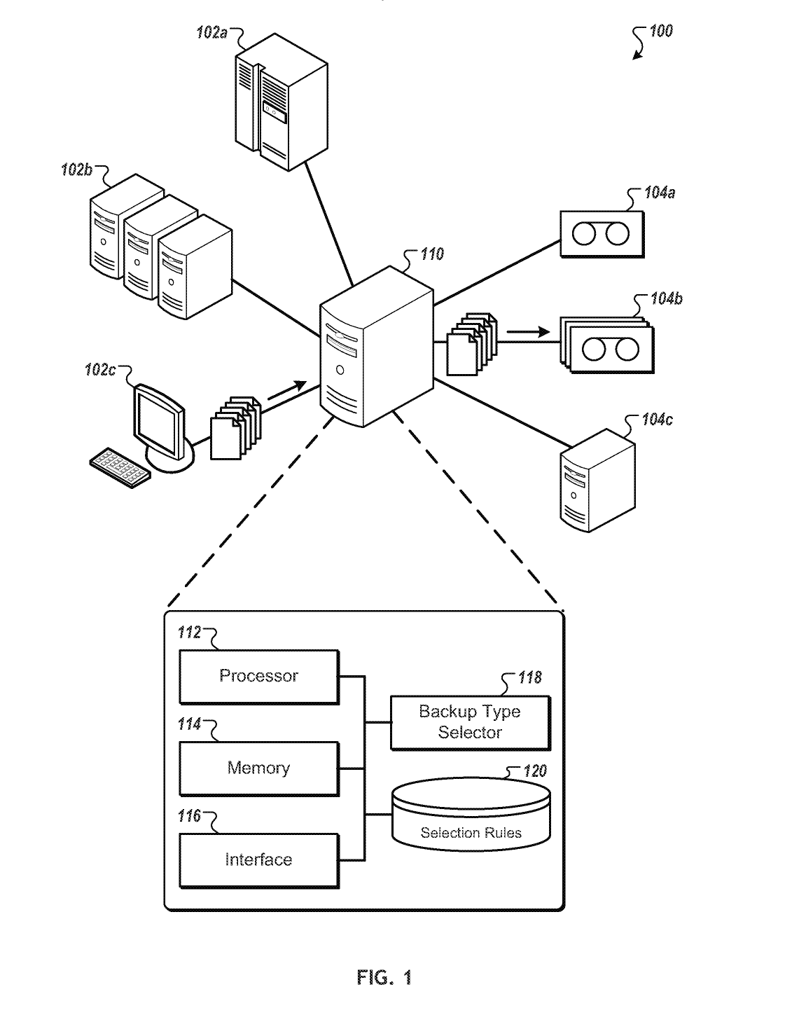

FIG. 1 shows a conceptual diagram of an example backup environment 100. Environment 100 may include multiple data sources 102a, 102b, and 102c, and may also include multiple backup devices 104a, 104b, and 104c. The multiple data sources 102a-102c may be communicatively coupled to the multiple backup devices 104a-104c via a backup management computing device 110, which may be configured to control and manage backup and restore processes. The various devices in environment 100 may be interconnected through one or more appropriate networks. The example topology of environment 100 may provide data backup capabilities representative of various backup environments. However, it should be understood that the example topology is shown for illustrative purposes only, and that various modifications may be made to the configuration. For example, backup environment 100 may include different or additional components, or the components may be connected in a different manner than is shown.

Data sources 102a-102c need not all be of the same type. Indeed, in many environments, data sources 102a-102c will typically vary in type. For example, in an enterprise environment, data sources 102a-102c might take the form of database server clusters, application servers, content servers, email servers, desktop computers, laptop computers, and the like. Similarly, backup devices 104a-104c may vary in type. For example, backup devices 104a-104c may include disk devices, tape devices, and/or tape libraries. Other appropriate types of backup devices may also be used.

In some environments, a source agent component may execute on each of the data sources 102a-102c, and a media agent component may execute on the backup management computing device 110. The source agent component may be responsible for reading the data from the host device as specified in a backup policy. The data to be backed up may include specific files, file systems, databases, email/file/web servers, or any other appropriate type of data. The media agent component may be responsible for accepting the data from the source agent component and writing it to a destination backup device and/or backup medium. In the example shown, data from data source 102c is being backed up to backup device 104b via the backup management computing device 110.

In some implementations, the source agent component itself may be responsible for writing the data directly to the backup devices, rather than routing the data via the backup management computing device 110. In such cases, the host computing devices may include the functionality for selecting the appropriate backup type to perform in accordance with the techniques described here. Similarly, in these or other implementations, the source agent component and the media agent component may be independent from a central backup management entity, and the agents may be controlled and managed independently.

As shown, the backup management computing device 110 may include a processor 112, a memory 114, an interface 116, a backup type selector 118, and a selection rules repository 120. It should be understood that the components shown here are for illustrative purposes, and that in some cases, the functionality being described with respect to a particular component may be performed by one or more different or additional components. Similarly, it should be understood that portions or all of the functionality may be combined into fewer components than are shown.

Processor 112 may be configured to process instructions for execution by the backup management computing device 110. The instructions may be stored on a non-transitory tangible computer-readable storage medium, such as in memory 114 or on a separate storage device (not shown), or on any other type of volatile or non-volatile memory that stores instructions to cause a programmable processor to perform the techniques described herein. Alternatively or additionally, backup management computing device 110 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

Interface 116 may be implemented in hardware and/or software, and may be configured, for example, to receive and respond to requested backup or restore operations. For example, interface 116 may be configured to receive data to be backed up from a data source, and may be configured to process and/or forward the data to be backed up to an appropriate backup device.

Interface 116 may also provide a user interface, such as a graphical user interface (GUI), that allows a backup administrator to define various backup policies. For example, the backup administrator may define backup policies that specify the source of data to be backed up, a schedule for performing the backups of that source, the type of backups to be performed, and other appropriate information. Examples of the types of backups to be performed may include full backups (where all of the selected data from a particular source is backed up), cumulative incremental backups (where all changes since the last full backup are backed up), differential incremental backups (where only the portions changed since the last full or cumulative incremental backup are backed up), or other appropriate types of backups. Some backup policies may include a combination of these alternatives (e.g., full backups on the weekend, followed by daily cumulative incremental backups during the week).

Interface 116 may also provide a user interface (e.g., a checkbox or other appropriate mechanism) that allows the backup administrator to either enable or disable the automatic backup type selection techniques described here. The automatic backup type selection techniques may be used to override the nominal backup type specified in the backup policy under appropriate circumstances. When the backup type selection techniques are disabled, the backup management computing device 110 may simply carry out the backup operations as specified in the backup policy—e.g., using the type of backup operation specified in the policy. When the backup type selection techniques are enabled, the backup management computing device 110 may instead determine, e.g., at runtime, whether to override the backup type specified in the backup policy by selecting a different backup type before performing the backup operation.

Backup type selector 118 may execute on processor 112, and may be configured to select the type of backup to perform for a particular backup operation. In the case of automatic backup type selection, such selection may be based on the amount of data that has changed on the data source that is to be backed up since a previous backup of the data source. For example, if a relatively large amount of data has changed on the data source since the last full backup, then a full backup may be selected for the backup operation even if the backup policy nominally specifies an incremental backup. Similarly, if a relatively small amount of data has changed on the data source since the last full backup, then an incremental backup may be selected for the backup operation even if the backup policy nominally specifies a full backup.

The backup type selection may be based on configurable selection rules and/or other appropriate criteria, which may be stored in selection rules repository 120. In some implementations, interface 116 may provide a user interface that allows a backup administrator to define the selection rules to be stored in repository 120. As one example of a selection rule that may be stored in repository 120, a full backup type may be used for a particular backup operation (regardless of the backup type specified in the backup policy) if the cumulative amount of data that has changed on the data source since a last full backup of the data source exceeds a configurable threshold value. The threshold value may be defined in relative terms (e.g., a value equal to a percentage of the size of changed data since the last full backup, such as 25%, 50%, 75%, or other appropriate percentage), or may be defined in absolute terms (e.g., a value equal to a specific amount of changed data, such as 10 GB or other appropriate amount). As another example of a selection rule that may be stored in repository 120, an incremental backup type may be used for a particular backup operation if the cumulative amount of data that has changed on the data source since a last full backup of the data source is lower than a configurable threshold value. Once again, the threshold value may be defined in relative terms (e.g., a value equal to a percentage of the size of changed data since the last full backup, such as 5%, 10%, 25%, or other appropriate percentage), or may be defined in absolute terms (e.g., a value equal to a specific amount of changed data, such as 1 GB or other appropriate amount). As described in both examples above, the relative threshold value may be based on the amount of data that was backed up during a previous backup operation (e.g., a last full backup operation).

It should be understood that these examples are provided for illustrative purposes only, and that the selection rules may be defined in any appropriate manner such that the type of backup to perform is selected based, in whole or in part, on the amount of data that has changed on the source device since a previous backup of the source.

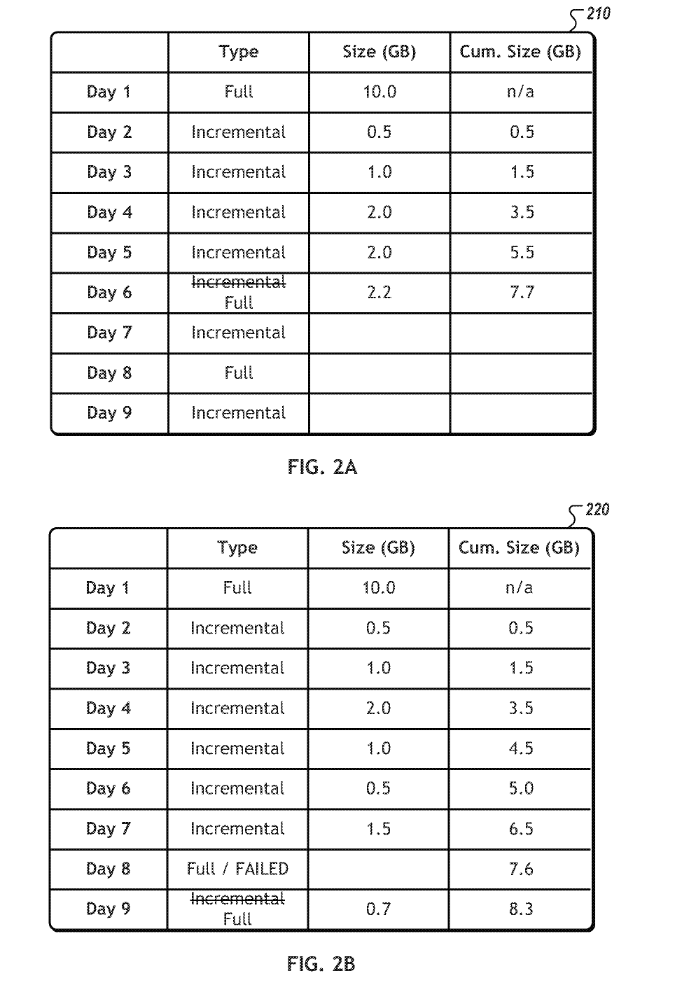

FIGS. 2A, 2B, and 2C show examples of backup scenarios 210, 220, and 230, respectively, where a backup type has been changed in accordance with the techniques described here. In backup scenarios 210, 220, and 230, a recurring schedule has been defined such that a full backup is scheduled for Day 1 of a particular cycle (e.g., on a Sunday evening), and incremental backups are scheduled for Days 2-7 of the cycle (e.g., for every evening Monday through Saturday). The cycle then repeats in an ongoing manner.

In backup scenario 210, the incremental backup scheduled for Day 6 of the cycle has been converted to a full backup based on the relatively large amount of data that has changed on the source device since a previous backup of the source. This may be as the result of a selection rule that specifies a full backup to be performed (regardless of the backup type specified in the policy) when the cumulative amount of changed data since the last full backup exceeds 75% of the last full backup size. In such an example, the 7.7 GB of cumulative changed data would exceed the threshold value of 7.5 GB (75% of 10 GB), so a full backup would be performed. This may also be as the result of a selection rule that specifies a full backup to be performed when the cumulative amount of changed data since the last full backup exceeds an absolute threshold value of 7 GB.

Backup scenario 220 is similar to backup scenario 210. In backup scenario 220, the incremental backup scheduled for Day 9 of the cycle has been converted to a full backup based on the relatively large amount of data that has changed on the source device since a previous backup of the source. In this example, the full backup scheduled for Day 8 failed, so the cumulative amount of changed data since the last full backup continued to increase rather than resetting. Assuming the same selection rules from backup scenario 210, the incremental backup scheduled for Day 9 of the scenario would be changed to a full backup based on the cumulative amount of changed data exceeding the given threshold value.

In backup scenario 230, the full backup scheduled for Day 8 of the cycle has been converted to an incremental backup based on the relatively small amount of data that has changed on the source device since a previous backup of the source. This may be as the result of a selection rule that specifies an incremental backup to be performed (regardless of the backup type specified in the policy) when the cumulative amount of changed data since the last full backup is less than 10% of the last full backup size. In such an example, the 0.9 GB of cumulative changed data would not meet the threshold value of 1.0 GB (10% of 10 GB), so an incremental backup would be performed. This may also be as the result of a selection rule that specifies an incremental backup to be performed when the cumulative amount of changed data since the last full backup does not meet an absolute threshold value of 2 GB.

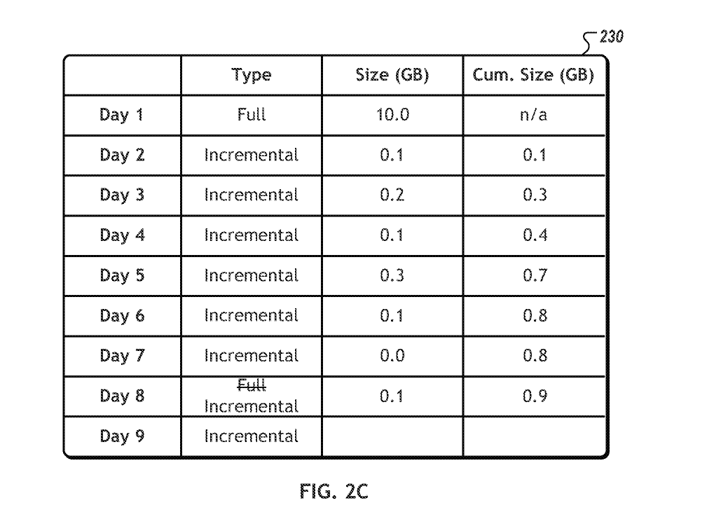

FIG. 3 shows a flow diagram of an example process 300 for performing a backup using a selected backup type. The process 300 may be performed, for example, by a backup management system, such as backup management computing device 110 illustrated in FIG. 1. For clarity of presentation, the description that follows uses the backup management computing device 110 as the basis of an example for describing the process. However, it should be understood that another system, or combination of systems, may be used to perform the process or various portions of the process.

Process 300 begins at block 310, in which a backup policy that describes a source of data is identified. For example, backup management computing device 110 may identify a backup policy associated with a particular data source. The backup policy may specify how and when to perform backup operations associated with the data source. For example, the backup policy may specify the data to be backed up, a schedule for performing the backups, the type of backups to be performed according to the schedule, and other appropriate information describing how the backup operations are to be performed. Some backup policies may specify a combination of backup types (e.g., full backups on the weekend, followed by daily cumulative incremental backups during the week).

At block 320, an amount of changed data since a previous backup of the source is determined. For example, backup management computing device 110 may calculate a difference between a previous successful backup (e.g., the most recent full backup) and an amount of data that has changed since the previous successful backup (e.g., a cumulative amount of changed data). The determination may be made at runtime before the backup operation is started.

At block 330, a backup type is selected for the backup operation based on the amount of changed data. For example, backup management computing device 110 may select an efficient type of backup to perform, even if the selected type of backup is different from the backup type specified in the backup policy. In some implementations, selecting the type of backup to perform may include comparing the amount of data that has changed on the source (e.g., since a previous backup of the source) to a threshold value. The threshold value may be defined either in absolute terms or in relative terms. For example, in some cases, the relative threshold value may be based on an amount (e.g., 25%, 50%, 75%, or some other specified percentage) of data backed up during a previous backup operation.

Depending on the amount of data that has changed on the source, the selected backup type may be different from the specified backup type that is described in the backup policy. For example, in some cases, the backup management computing device 110 may select a full backup to be performed even if the specified backup type is an incremental backup. In such cases, at least a portion of data from the source will be backed up sooner than if the backup operation was performed using the specified incremental backup, which may also decrease the time necessary for restoration of the data. Similarly, the backup management computing device 110 may select an incremental backup to be performed even if the specified backup type is a full backup. In such cases, less storage space may be utilized, and the time to complete the backup operation may be decreased.

At block 340, the backup is caused to be performed using the selected backup type. For example, backup management computing device 110 may cause the appropriate data to be copied from the source computing device to an appropriate backup device, using the appropriate backup type (e.g., full, incremental, differential, or other appropriate backup type).

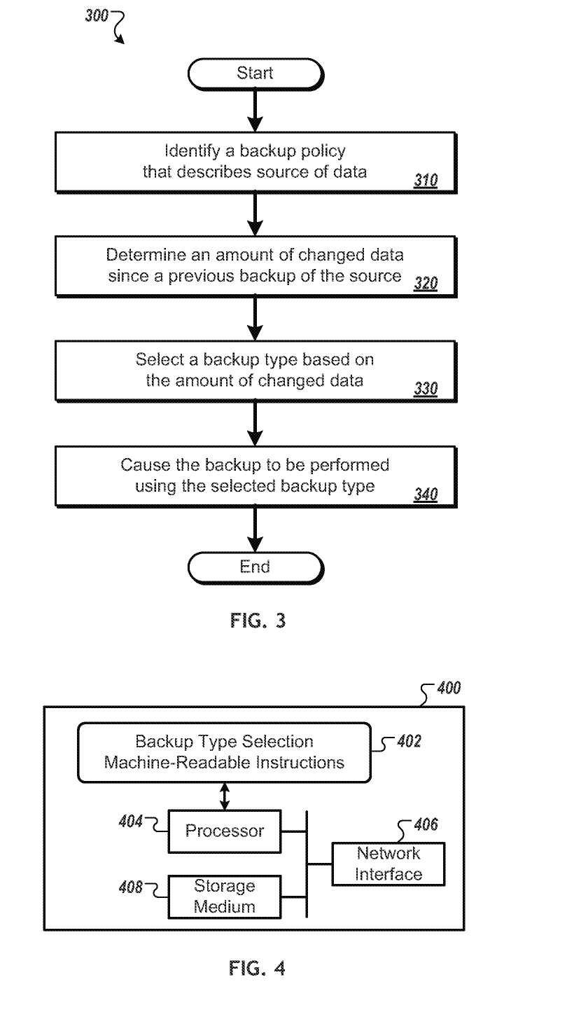

FIG. 4 shows a block diagram of an example system 400, which may be representative of the computing devices of FIG. 1. The system 400 includes backup type selection machine-readable instructions 402, which may include certain of the various modules of the computing devices depicted in FIG. 1. The backup type selection machine-readable instructions 402 are loaded for execution on a processor or processors 404. A processor can include a microprocessor, microcontroller, processor module or subsystem, programmable integrated circuit, programmable gate array, or another control or computing device. The processor(s) 404 can be coupled to a network interface 406 (to allow the system 400 to perform communications over a data network) and a storage medium (or storage media) 408.

The storage medium 408 can be implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other appropriate types of storage devices. Note that the instructions discussed above can be provided on one computer-readable or machine-readable storage medium, or alternatively, can be provided on multiple computer-readable or machine-readable storage media distributed in a system having possibly plural nodes. Such computer-readable or machine-readable storage medium or media is (are) considered to be part of an article (or article of manufacture). An article or article of manufacture can refer to any appropriate manufactured component or multiple components. The storage medium or media can be located either in the machine running the machine-readable instructions, or located at a remote site, e.g., from which the machine-readable instructions can be downloaded over a network for execution.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

What is claimed is:

1. A computer-implemented method comprising:
identifying, using a computing system, a backup policy that describes a source of data to be backed up during a backup operation;
determining, using the computing system, an amount of data that has changed on the source since a previous backup of the source;
selecting, using the computing system, a type of backup to perform based on the amount of data that has changed on the source; and
causing, using the computing system, the backup operation to be performed using the selected type of backup.

2. The computer-implemented method of claim 1, wherein selecting the type of backup to perform comprises comparing the amount of data that has changed on the source to a threshold value that is based on an amount of data backed up during a previous backup operation.

3. The computer-implemented method of claim 2, wherein the previous backup operation is a most recent full backup of the source.

4. The computer-implemented method of claim 1, wherein the selected type of backup is different from a specified backup type described in the backup policy.

5. The computer-implemented method of claim 4, wherein the selected type of backup is an incremental backup and the specified backup type described in the backup policy is a full backup.

6. The computer-implemented method of claim 4, wherein the selected type of backup is a full backup and the specified backup type described in the backup policy is an incremental backup.

7. The computer-implemented method of claim 6, wherein at least a portion of data from the source is backed up sooner than if the backup operation was performed using the specified backup type described in the backup policy.

8. A system comprising:
a source computing system that stores source data; and
a backup management computing system that selects a type of backup to perform on the source data based on an amount of the source data that has changed since a previous backup of the source data, and causes the selected type of backup to be performed on the source data.

9. The system of claim 8, wherein the backup management computing system selects the type of backup to perform by comparing the amount of the source data that has changed to a threshold value that is based on an amount of data backed up during a most recent full backup of the source data.

10. The system of claim 9, wherein the backup management computing system selects a full backup in response to determining that the amount of the source data that has changed is greater than the threshold value.

11. The system of claim 9, wherein the backup management computing system selects an incremental backup in response to determining that the amount of the source data that has changed is less than the threshold value.

12. A non-transitory, computer-readable storage medium storing instructions that, when executed by one or more processors, cause the one or more processors to:
identify a backup policy that describes a source of data to be backed up during a backup operation;
determine an amount of data that has changed on the source since a most recent full backup of the source;
select a type of backup to perform based on the amount of data that has changed on the source; and
cause the backup operation to be performed using the selected type of backup.

13. The non-transitory, computer-readable storage medium of claim 12, wherein the selected type of backup is different from a specified backup type described in the backup policy.

14. The non-transitory, computer-readable storage medium of claim 13, wherein the selected type of backup is a full backup and the specified backup type described in the backup policy is an incremental backup.

15. The non-transitory, computer-readable storage medium of claim 13, wherein the selected type of backup is an incremental backup and the specified backup type described in the backup policy is a full backup.
